(19) United States
(12) Patent Application Publication
(10) Pub. No.: US 2014/0146836 A1
(43) Pub. Date: May 29, 2014

(54) METHOD FOR VIDEO STREAMING AND AN ELECTRONIC DEVICE THEREOF

(71) Applicant: Samsung Electronics Co. Ltd., Suwon-si (KR)

(72) Inventors: Tae-Hyung KIM, Yongin-si (KR); Jung-Wook CHAI, Seoul (KR)

(73) Assignee: Samsung Electronics Co. Ltd., Suwon-si (KR)

(21) Appl. No.: 14/091,615

(22) Filed: Nov. 27, 2013

(30) Foreign Application Priority Data
Nov. 29, 2012 (KR) 10-2012-0136920

(51) Int. Cl. H04L 29/06

(52) U.S. Cl. CPC H04L 65/601
USPC 370/474

(57) ABSTRACT

A video transmitting method for video streaming is provided. The method includes generating a video packet including one video frame, transmitting at least one transport packet generated using the video packet, and transmitting a dummy transport packet for indicating a boundary of the video packet if a size of the video frame exceeds a threshold.

### CROSS-REFERENCE TO RELATED APPLICATION(S)

This application claims the benefit under 35 U.S.C. §119(a) of a Korean patent application filed on Nov. 29, 2012 in the Korean Intellectual Property Office and assigned Serial No. 10-2012-0136920, the entire disclosure of which is hereby incorporated by reference.

### TECHNICAL FIELD

The present disclosure relates to a method of video streaming and an electronic device thereof

### BACKGROUND

Video streaming is a digital video technique which uses a communication means so that video content stored on one side are reproduced on another side. Therefore, according to the video streaming technique, video content can be reproduced without having to store entire data associated with the video content.

The video streaming is used in various types of services such as a Video On Demand (VOD) service, a video telephony service, a WiFi Display (WFD), and the like. A receiving device for receiving a video streaming service reproduces video data at the same time as receiving the video data. In this case, for seamless and smooth reproduction, the video data is generally subjected to sufficient buffering. As a result of the buffering, even if video data transmission is temporarily stopped, video reproduction can be seamlessly achieved on a receiving side as long as buffered data is not entirely consumed.

However, the greater the size of buffering (e.g., the extent to which the video data is buffered), the poorer the real-timeness of video reproduction. In other words, the greater the size of buffering, the greater the difference between a time at which video data is transmitted from a transmitting side and a time at which the transmitted video data is reproduced on a receiving side. If a provided service simply focuses on only reproduction of video content, the real-timeness of video reproduction may not be an important criterion of service quality. However, if an application which requires an immediate response such as a game service, the real-timeness of video reproduction may be important to the service quality. Therefore, there is a need for a method of enhancing real-timeness in a video streaming service.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for enhancing real-timeness in a video streaming service.

Another aspect of the present disclosure is to provide an apparatus and method for decreasing a latency when video data is delivered in a video streaming service.

Another aspect of the present disclosure is to provide an apparatus and method for indicating a boundary of a large-sized video packet in a video streaming service.

In accordance with another aspect of the present disclosure, a video transmitting method for video streaming is provided. The method includes generating a video packet including one video frame, transmitting at least one transport packet generated using the video packet, and transmitting a dummy transport packet for indicating a boundary of the video packet if a size of the video frame exceeds a threshold.

In accordance with another aspect of the present disclosure, a video transmitting apparatus for video streaming is provided. The apparatus includes a controller configured to generate a video packet including one video frame, a communicator configured to transmit at least one transport packet generated using the video packet, and to transmit a dummy transport packet for indicating a boundary of the video packet if a size of the video frame exceeds a threshold.

In accordance with another aspect of the present disclosure, a method in a video receiving method for video streaming is provided. The method includes receiving at least one transport packet which is generated using a video packet which includes one video frame, receiving a dummy transport packet if a size of the video frame exceeds a threshold, and determining a boundary of the video packet based on the dummy transport packet, if the size of the video frame exceeds the threshold.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates video data processing according to an embodiment of the present disclosure;

FIG. 2 illustrates video packets according to an embodiment of the present disclosure;

FIG. 3 illustrates a large-sized video packet according to an embodiment of the present disclosure;

FIG. 4 illustrates a method of indicating a boundary of a large-sized video packet according to an embodiment of the present disclosure;

FIGS. 5A, 5B, 5C, 5D, and 5E illustrate examples of configuring a dummy packet according to an embodiment of the present disclosure;

FIG. 6 illustrates a process of operating a video transmitting device according to an embodiment of the present disclosure;

FIG. 7 is a block diagram of a video transmitting device according to an embodiment of the present disclosure; and

FIG. 8 is a block diagram of a video transmitting device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As a non-exhaustive illustration only, an electronic device described herein may refer to mobile devices such as a cellular phone, a Personal Digital Assistant (PDA), a digital camera, a portable game console, an MP3 player, a portable/personal multimedia player (PMP), a handheld e-book, a portable lap-top PC, a Global Positioning System (GPS) navigation, and devices such as a desktop PC, a high definition television (HDTV), an optical disc player, a set-top box, a media server, a content server, and the like capable of wireless communication or network communication consistent with that disclosed herein.

The present disclosure relates to an apparatus and method for enhancing the effectiveness of video streaming a service in real time. Various embodiments of the present disclosure described hereinafter relate to a technique for decreasing a latency when video data is delivered in a video streaming service.

As an example, a Moving Picture Experts Group-2 Transport Stream (MPEG2 TS)-based transmission system according to various embodiments of the present disclosure will be described. However, various embodiments of the present disclosure are not limited to the MPEG2 TS system. Accordingly, various embodiments of present disclosure may also be equally applicable to a streaming service conforming to another protocol.

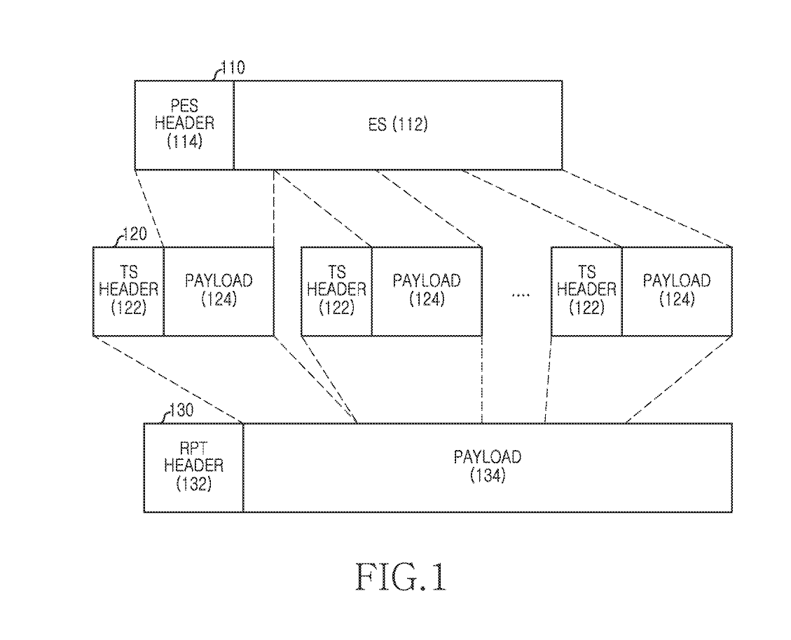

FIG. 1 illustrates video data processing according to an embodiment of the present disclosure.

Referring to FIG. 1, each frame constituting video data is encoded to an Elementary Stream (ES) 112 by using an encoder, and a Packetized ES (PES) header 114 is attached to the ES 112 to generate a PES packet 110. A size of the ES 112 may vary depending on a type of a frame and an image included in the frame. The PES packet 110 is divided by a specific size, and a Transport Stream (TS) header 122 is attached to each divided portion to generate a TS packet 120. In general, the PES packet 110 is greater than one payload 124 of the TS packet 120, and thus a plurality of TS packets 120 are generated from one PES packet 110.

The TS packets 120 are processed according to a communication protocol and are then transmitted to a receiving device. With reference to FIG. 1, the TS packets 120 are transmitted in a form of a Real-time Transport Protocol (RTP) packet 130. For example, the RTP packet 130 is generated by attaching an RTP header 132 to a payload 134 including at least one TS packet 120, and the RTP packet 130 is delivered to the receiving device. Accordingly, the receiving device can reproduce video content by restoring the TS packets 120 from the RTP packet 130 and by restoring the PES packet 110 from the TS packets 120.

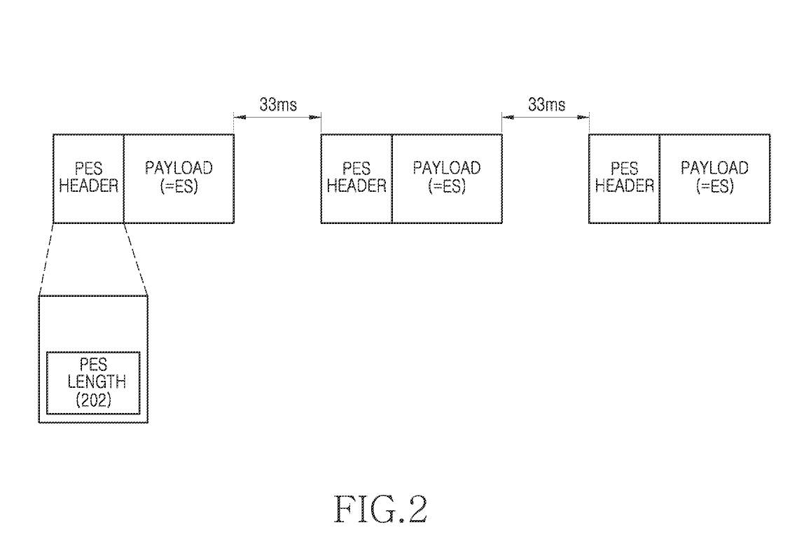

FIG. 2 illustrates video packets according to an embodiment of the present disclosure.

Referring to FIG. 2, PES packets generated in a transmitting side are illustrated.

Video content includes a plurality of consecutive still images. Each still image is called a frame. For example, the video content is reproduced by displaying a plurality of still images within a unit time. In general, the unit time may be 30 frame per second (fps), 24 fps, or the like. If the unit time within which the plurality of still images are displayed is 30 fps, a time interval between frames is about 33 millisecond (ms). For example, one frame is output every 33 ms.

Therefore, as illustrated in FIG. 2, according to various embodiments of the present disclosure, in a streaming service, a PES packet is transmitted every 33 ms (e.g., under the assumption that the unit time within which the plurality of still images are displayed is 30 fps). As illustrated in FIG. 1, the PES packet includes a header and a payload. In addition, as illustrated in FIG. 2, the header includes a ‘PES length’ field 202. The PES length field indicates a length of the PES packet. A receiving device can determine a length of the PES packet received by using the PES length field 202, and can know (e.g., determine) a boundary of the PES packet on the basis of the determined length. According to an MPEG2 protocol, the PES length field 202 has a size of 2 bytes. As a result of the size of the PES length field 202 being 2 bytes, the PES length field 202 can express a value in the range of 0 to 65535.

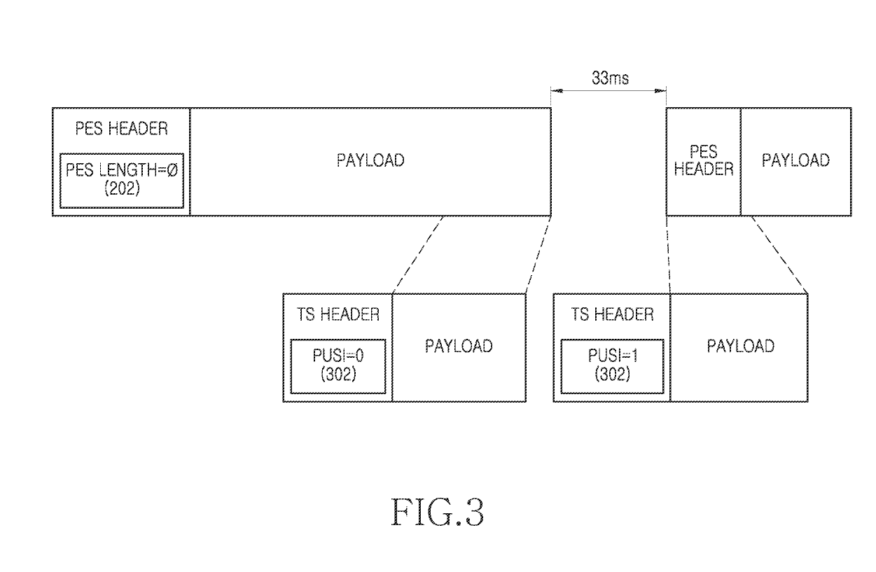

However, with the advancement of hardware performance for video reproduction, a size of video data is increased. Consequently, a PES packet may be generated in a size exceeding 65535 bytes. In this case, because the PES length field 202 cannot express an end point of the packet, a header of a TS packet is used. A boundary of the PES packet using the header of the TS packet is identified as illustrated in FIG. 3.

FIG. 3 illustrates a large-sized video packet according to an embodiment of the present disclosure.

Referring to FIG. 3, if a size of a PES packet exceeds 65535 bytes, a PES length field 202 is set to ‘0’. Accordingly, a receiving device may determine that a length of the received PES packet exceeds a range that can be expressed by the PES length field 202. In addition, an end point of the PES packet having a size exceeding 65535 bytes can be expressed by indicating a start point of a next PES packet.

As described in FIG. 1, the PES packet is divided into at least one TS packet. Accordingly, one of the TS packets may include a start portion of the PES packet, at least another TS packet may include a middle portion of the PES packet, and another TS packet may include an end portion of the PES packet. In this case, in order to indicate that the start portion of the PES packet is included, a header of the TS packet includes a Payload Unit Start Indicator (PUSI) field 302 which is set to ‘1’. Therefore, by using the PUSI field 302, the receiving device can identify (e.g., determine) a boundary of the PES packet.

In other words, if the size of the PES packet exceeds 65535 bytes, the receiving device sets the PES length field 202 of the PES packet to ‘0’. In this case, the receiving device can identify the boundary of the PES packet by using the PUSI field 302 in the header of the TS packet including the start portion of the next PES packet.

However, if the size of the PES packet exceeds 65535 bytes, even though the PES packet is entirely received, the receiving device cannot identify the boundary of the PES packet until a first TS packet of the next PES packet is received. For example, in case of video content of 30 fps, two PES packets are transmitted with a time interval of 33 ms. Therefore, a time latency of 33 ms occurs in the processing of the received PES packet. If the number of frames per unit time is decreased, the time latency is further increased. As a result, the decrease in the time latency for the identification of the boundary of the large-sized PES packet is necessarily required to improve real-timeness of video streaming (e.g., to improve the effectiveness of video streaming in real-time). Accordingly, the present disclosure proposes the following method to decrease the time latency to identify the boundary of the PES packet.

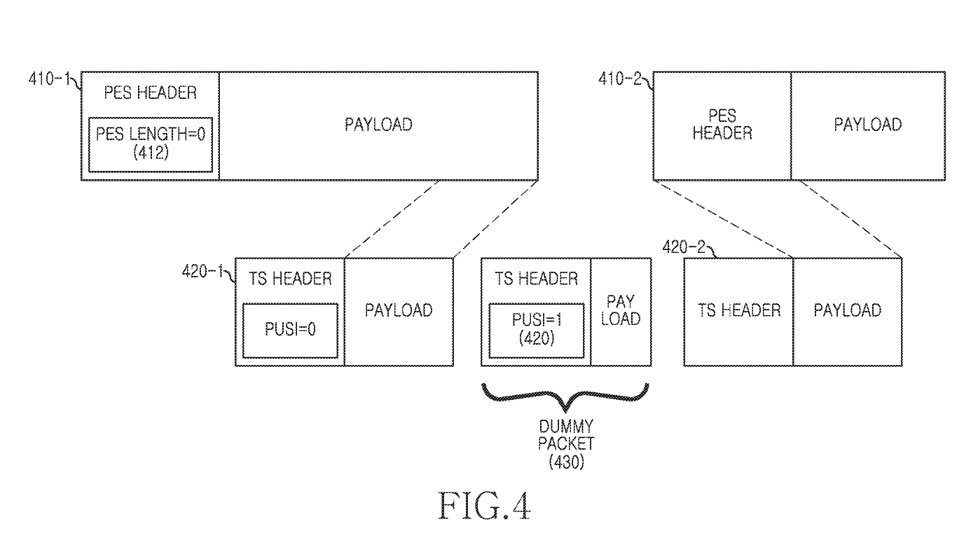

FIG. 4 illustrates a method of indicating a boundary of a large-sized video packet according to an embodiment of the present disclosure.

Referring to FIG. 4, a 1^{st} PES packet 410-1 has a length which exceeds a value that can be expressed by a PES length field 412. Accordingly, the PES length field 412 in a header of the 1^{st} PES packet 410-1 is set to ‘0’. Therefore, even though a 1^{st} TS packet 420-1 including an end portion of the 1^{st} PES packet 410-1 is received, a receiving device cannot identify a boundary of the 1^{st} PES packet 410-1.

To identify the boundary of the 1^{st} PES packet 410-1, the receiving device transmits a dummy packet 430 subsequently to the 1^{st} TS packet 420-1. The dummy packet 430 includes a header and a payload similar to a typical TS packet. A PUSI field 420 in a header of the dummy packet 430 is set to ‘1’. Accordingly, the receiving device can identify the boundary of the 1^{st} PES packet 410-1 by receiving the dummy packet 430. As described above, if the unit time within which the plurality of still images are displayed is 30 fps, the dummy packet 430 is transmitted prior to a 1^{st} TS packet 420-2 of a 2^{nd} PES packet 410-2 transmitted after 33 ms elapses from transmission of the 1^{st} PES packet 410-1, and thus the boundary of the 1^{st} PES packet can be identified (e.g., determined) without a time latency.

Because the dummy packet 430 is used to identify a boundary of only an immediately previous PES packet, a payload of the dummy packet 430 acts as an overhead. Therefore, the payload of the dummy packet 430 is preferably small in size.

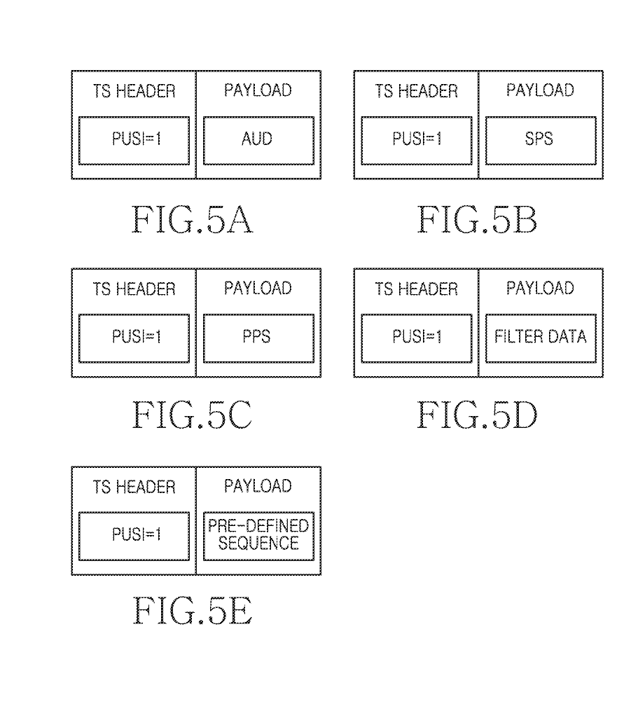

FIGS. 5A, 5B, 5C, 5D, and 5E illustrate examples of configuring a dummy packet according to an embodiment of the present disclosure.

Referring to FIGS. 5A, 5B, 5C, 5D, and 5E as a payload, an Access Unit Delimiter (AUD), a Sequence Parameter Set (SPS), a Picture Parameter Set (PPS), filter data, and a pre-defined sequence are respectively included in FIG. 5A, FIG. 5B, FIG. 5C, FIG. 5D, and FIG. 5D.

The AUD, the SPS, and the PPS are data generated in a Network Abstraction Layer (NAL) in image encoding based on an H.264 codec of the filter data, and include auxiliary information other than image data. The AUD includes information indicating a first portion of an access unit. The SPS includes information used throughout encoding of a whole sequence, such as a profile, a level, and the like. The PPS includes information regarding an encoding mode (e.g., entropy encoding mode) of a whole picture. The filter data includes dummy data used to fit a format. The AUD, the SPS, the PPS, and the filter data are small in size in comparison with an image frame, and can be used as a payload of the dummy packet because the AUD, the SPS, the PPS, and the filter data do not have an effect on image reproduction even if received in a receiving device. The pre-defined sequence of FIG. 5E implies a specific sequence having a value for indicating a dummy packet.

Referring to FIG. 5E, a value pre-determined between a transmitting device and the receiving device must be used to avoid an erroneous operation.

The AUD, SPS, PPS, filter data, and pre-defined sequence of FIGS. 5A, 5B, 5C, 5D, and 5E are only examples of the payload of the dummy packet, and thus data different from that of the examples of FIGS. 5A, 5B, 5C, 5D, and 5E may also be included as the payload of the dummy packet.

Hereinafter, an operation and structure of a transmitting device for transmitting a video packet as described above will be decreased in detail with reference to the accompanying drawings.

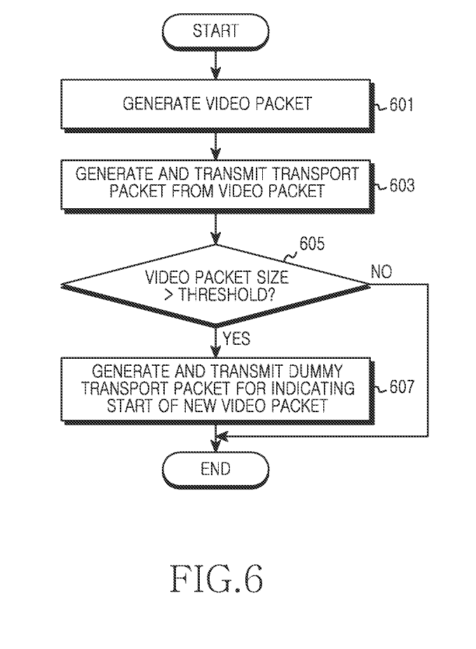

FIG. 6 illustrates a process of operating a video transmitting device according to an embodiment of the present disclosure.

Referring to FIG. 6, a process of transmitting one video frame according to various embodiments of the present disclosure is illustrated.

According to various embodiments of the present disclosure, when providing a video streaming service, the transmitting device transmits a plurality of video frames, and the procedure of FIG. 6 is repetitively performed with a specific time interval.

At operation 601, the transmitting device generates a video packet. In other words, the transmitting device encodes video data, and thereafter attaches a video packet header. The video packet header includes a length field for indicating a length of the video packet. As an example, if the length of the video packet is out of a range that can be expressed by the length field, then the transmitting device sets the length field to 0. The transmitting device may encode one frame to one video packet. For example, the video packet may be a PES packet.

At operation 603, the transmitting device generates at least one transport packet from the video packet, and transmits the at least one transport packet. More specifically, the transmitting device divides the video packet by a payload size of the transport packet, and attaches a transport packet header to each divided portion to generate at least one transport packet. In addition, the transport packets are processed and transmitted according to a transport protocol. For example, the transport packet may be a TS packet.

At operation 605, the transmitting device determines whether a size of the video packet exceeds a threshold. The threshold is a maximum value that can be expressed by the length field in the video packet header. For example, the transmitting device determines whether the video packet has a length in a range that can be expressed by the length field. In other words, the transmitting device may determine whether a length field value in the video packet header is ‘0’.

If the transmitting device determines that the video packet size exceeds the threshold at operation 605, then the transmitting device proceeds to operation 607 at which the transmitting device generates a dummy transport packet for indicating a start of a new video packet, and transmits the dummy transport packet. In other words, the transmitting device generates and transmits the dummy transport packet including information which indicates that a previous transport packet is a boundary of a video packet. More specifically, a header of the dummy transport packet includes an indicator for indicating a start of a new video packet. For example, if the transport packet is a TS packet, the header of the dummy transport packet includes a PUSI which is set to ‘1’.

Otherwise, if the transmitting device determines that the size of the video packet does not exceed the threshold at operation 605, then the procedure of FIG. 6 ends. Although not shown in FIG. 6, in order to transmit a video packet including a next frame, the transmitting device may repeat the procedure of FIG. 6.

The method described above in relation with FIG. 6 under of the present disclosure may be provided as one or more instructions in one or more software modules, or computer programs stored in an electronic device.

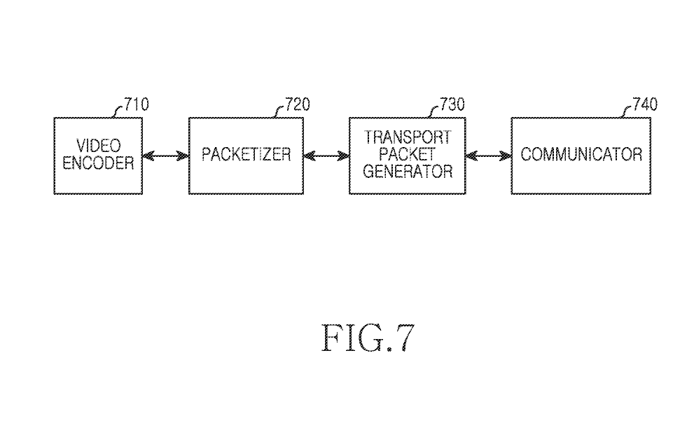

FIG. 7 is a block diagram of a video transmitting device according to an embodiment of the present disclosure. The present disclosure may be implemented in the transmitting device including a portable terminal such as, for example, a smart phone and a mobile telecommunication terminal Hereunder, a portable terminal is used as an example for the transmitting device.

Referring to FIG. 7, the video transmitting device is an electronic device.

The transmitting device includes a video encoder 710, a packetizer 720, a transport packet generator 730, and a communicator 740.

The video encoder 710 encodes video data according to a video compression protocol defined in a service. For example, the video encoder 710 may perform encoding according to an H.264 protocol.

The packetizer 720 generates a video packet including the encoded video data. For example, the packetizer 720 attaches a video packet header to the encoded video data. In this case, the video packet header includes a length field for indicating a length of the video packet. If the length of the video packet is out of a range that can be expressed by the length field, the transmitting device sets the length field to 0. For example, the video packet may be a PES packet.

The transport packet generator 730 generates at least one transport packet from the video packet generated by the packetizer 720. More specifically, the transport packet generator 730 divides the video packet by a payload size of the transport packet, and attaches a transport packet header to each divided portion to generate at least one transport packet. For example, the transport packet may be a TS packet. Further, according to the various embodiments of the present disclosure, the transport packet generator 730 determines whether the video packet size exceeds the threshold, and if the video packet size exceeds the threshold, the transport packet generator 730 generates a dummy transport packet for indicating a start of a new video packet. In other words, the transport packet generator 730 generates the dummy transport packet including information which indicates that a previous transport packet is a boundary of the video packet. More specifically, a header of the dummy transport packet includes an indicator for indicating a start of a new video packet. For example, if the transport packet is a TS packet, the header of the dummy transport packet includes a PUSI which is set to 1.

The communicator 740 transmits to a receiving device at least one transport packet generated by the transport packet generator 730. The communicator 740 can support a wireless interface or a wired interface. When supporting the wireless interface, the communicator 740 may include a modem, an amplifier, a mixer, an oscillator, a Digital to Analog Converter (DAC), an Analog to Digital Converter (ADC), and/or the like.

Although not shown in FIG. 7, the transmitting device may include a block for packetizing transport packets generated by the transport packet generator 730 according to a transport protocol. For example, the transport protocol may be an RTP. In this case, a plurality of transport packets may be transmitted as a payload of one RTP packet.

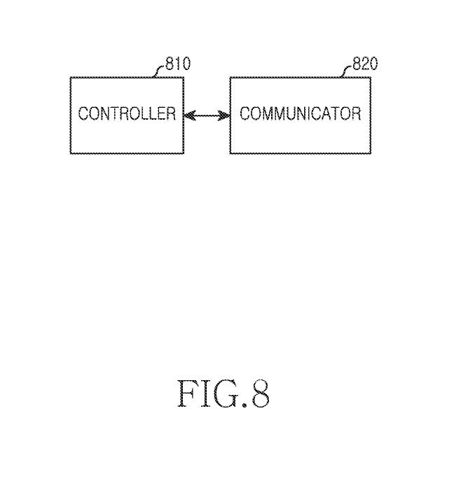

FIG. 8 is a block diagram of a video transmitting device according to an embodiment of the present disclosure. The present disclosure may be implemented in the transmitting device including a portable terminal such as, for example, a smart phone and a mobile telecommunication terminal Hereunder, a portable terminal is used as an example for the transmitting device.

Referring to FIG. 8, the video transmitting device is an electronic device.

The transmitting device includes a controller 810 and a communicator 820.

The controller 810 performs functions of the video encoder 710, packetizer 720, and transport packet generator 730 of FIG. 7. For example, the controller 810 includes at least one processor. The at least one processor is a physical device encoded to perform the functions of the video encoder 710, the packetizer 720, and the transport packet generator 730, or is a device for performing a software module which implements the functions of the video encoder 710, the packetizer 720, and the transport packet generator 730.

The communication unit 820 transmits at least one transport packet generated by the controller 810 to a receiving device, and can support a wireless interface or a wired interface.

The transmitting device of FIG. 8 according to the various embodiments of the present disclosure may be a portable electronic device. For example, the transmitting device may be one of a smart phone, a portable terminal, a mobile phone, a mobile pad, a media player, a tablet computer, a handheld computer, and a Personal Digital Assistant (PDA). Further, the transmitting device may be a device which combines two or more functions of the aforementioned devices. Furthermore, the transmitting device may be a device which does not have mobility.

Methods based on the embodiments disclosed in the claims and/or specification of the present disclosure can be implemented in hardware, software, or a combination of both.

When implemented in software, a non-transitory computer readable recording medium for storing one or more programs (e.g., software modules) can be provided. The one or more programs stored in the non-transitory computer readable recording medium are configured for execution performed by one or more processors in an electronic device such as a portable terminal. The one or more programs include instructions for allowing the electronic device to execute the methods based on the embodiments disclosed in the claims and/or specification of the present disclosure.

The program (e.g., the software module or software) can be stored in a random access memory, a non-volatile memory including a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs) or other forms of optical storage devices, and a magnetic cassette. Alternatively, the program can be stored in a memory configured in combination of all or some of these storage media. In addition, the configured memory may be plural in number.

Further, the program can be stored in an attachable storage device capable of accessing the electronic device through a communication network such as the Internet, an Intranet, a Local Area Network (LAN), a Wide LAN (WLAN), or a Storage Area Network (SAN) or a communication network configured by combining the networks. The storage device can access via an external port to the device for performing the various embodiments of the present disclosure. Furthermore, an additional storage device on the communication network can access to the device for performing the various embodiments of the present disclosure.

According to various embodiments of the present disclosure, a time latency caused by a video frame interval can be removed by transmitting a dummy packet subsequently to a large-sized packet in a video streaming service, thereby enhancing real-timeness of the streaming service (e.g., enhancing the effectiveness of video streaming a service in real time). As a result, service satisfaction can be improved when providing a latency sensitive application.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device, the method comprising:
generating a video packet including one video frame;
transmitting at least one transport packet generated using the video packet; and
transmitting a dummy transport packet for indicating a boundary of the video packet if a size of the video frame exceeds a threshold.

2. The method of claim 1, wherein the dummy transport packet includes an indicator for indicating a start of a new video packet.

3. The method of claim 2, wherein the video packet is a Packetized Elementary Stream (PES) packet,
wherein the transport packet is a Transport Stream (TS) packet, and
wherein the indicator is a Payload Unit Start Indicator (PUSI) which is set to 1.

4. The method of claim 1, further comprising
transmitting at least one transport packet generated from a video packet including another frame after a frame interval time elapses.

5. The method of claim 4, wherein the dummy transport packet is transmitted prior to transmission of the at least one transport packet transmitted in association with the video packet including another frame.

6. The method of claim 1, wherein as a payload, the dummy transport packet includes at least one of an Access Unit Delimiter (AUD), a Sequence Parameter Set (SPS), a Picture Parameter Set (PPS), filter data, and a pre-defined sequence.

7. The method of claim 1, wherein the video packet includes a length field for indicating a length of the video packet, and
wherein the length field is set to ‘0’ if the length of the video packet exceeds the threshold.

8. The method of claim 7, wherein the threshold is a maximum value that can be expressed by the length field.

9. An electronic device comprising:
a controller configured to generate a video packet including one video frame;
a communicator configured to transmit at least one transport packet generated using the video packet, and to transmit a dummy transport packet for indicating a boundary of the video packet if a size of the video frame exceeds a threshold.

10. The device of claim 9, wherein the dummy transport packet includes an indicator for indicating a start of a new video packet.

11. The device of claim 10, wherein the video packet is a Packetized Elementary Stream (PES) packet,
wherein the transport packet is a Transport Stream (TS) packet, and
wherein the indicator is a Payload Unit Start Indicator (PUSI) which is set to 1.

12. The device of claim 9, wherein the communicator transmits at least one transport packet generated from a video packet including another frame after a frame interval time elapses.

13. The device of claim 12, wherein the dummy transport packet is transmitted prior to transmission of the at least one transport packet transmitted in association with the video packet including another frame.

14. The device of claim 9, wherein as a payload, the dummy transport packet includes at least one of an Access Unit Delimiter (AUD), a Sequence Parameter Set (SPS), a Picture Parameter Set (PPS), filter data, and a pre-defined sequence.

15. The device of claim 9, wherein the video packet includes a length field for indicating a length of the video packet, and
wherein the length field is set to ‘0’ if the length of the video packet exceeds the threshold.

16. The device of claim 15, wherein the threshold is a maximum value that can be expressed by the length field.

17. A non-transient computer readable storage medium storing one or more programs comprising instructions that, when executed by an electronic device, allow the electronic device to perform the method of claim 1.

18. A method in an electronic device, the method comprising:
receiving at least one transport packet which is generated using a video packet which includes one video frame;
receiving a dummy transport packet if a size of the video frame exceeds a threshold;
determining a boundary of the video packet based on the dummy transport packet, if the size of the video frame exceeds the threshold.

19. A non-transient computer-readable storage medium storing one or more programs comprising instructions that, when executed by an electronic device, allow the electronic device to perform the method of claim 18.
